(19) United States
(12) Patent Application Publication
(10) Pub. No.: US 2008/0028462 A1
(43) Pub. Date: Jan. 31, 2008

(54) SYSTEM AND METHOD FOR LOADING AND ANALYZING FILES

(76) Inventor: Michael Burtscher, Longmont, CO (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/460,074

(22) Filed: Jul. 26, 2006

(51) Int. Cl. G06F 12/14

(52) U.S. Cl. 726/22

(57) ABSTRACT

A system and method for analyzing files on a computer is described. In one embodiment the system includes a loader module configured to sequentially receive code from a plurality of files stored on a computer-readable medium and initiate execution of the code in a process space of the loader module. In addition, the loader module is configured to stop execution of the code in response to the code attempting to carry out particular instructions while executing. The system also includes a detection module configured to analyze the code from each of the plurality of files after the code is loaded by the loader module.

### RELATED APPLICATIONS

The present application is related to commonly owned and assigned application no. [unassigned], Attorney Docket No. WEBR-037/00US, entitled SYSTEM AND METHOD FOR ANALYZING PACKED FILES, which is incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect and remove pestware by scanning a system for files stored in a data storage device (e.g., disk) on a file by file basis and comparing information from each of the files with known pestware definitions. Problematically, generators of pestware are obfuscating pestware files (e.g., by encrypting and/or compressing them) so as to create pestware files that, at the very least, are very difficult to identify by comparing them with known pestware definitions. As a consequence, existing software often leaves obfuscated files in the system because of uncertainty whether the file is associated with a desired application. Accordingly, current software is not always able to scan and remove pestware in a convenient manner and will most certainly not be satisfactory in the future.

Although present devices are functional, they are not sufficiently accurate or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for analyzing files on a computer. In one embodiment the system includes a loader module configured to sequentially receive code from a plurality of files stored on a computer-readable medium and initiate execution of the code in a process space of the loader module. In addition, the loader module is configured to stop execution of the code in response to the code attempting to carry out particular instructions while executing. The system also includes a detection module configured to analyze the code from each of the plurality of files after the code is loaded by the loader module.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a block diagram of a protected computer in accordance with one implementation of the present invention; and

FIG. 2 is a flowchart of one method for identifying pestware in accordance with an embodiment of the present invention; and

FIG. 3 is a flowchart depicting steps carried out while scanning a potential pestware process in accordance with variations of the present invention.

### DETAILED DESCRIPTION

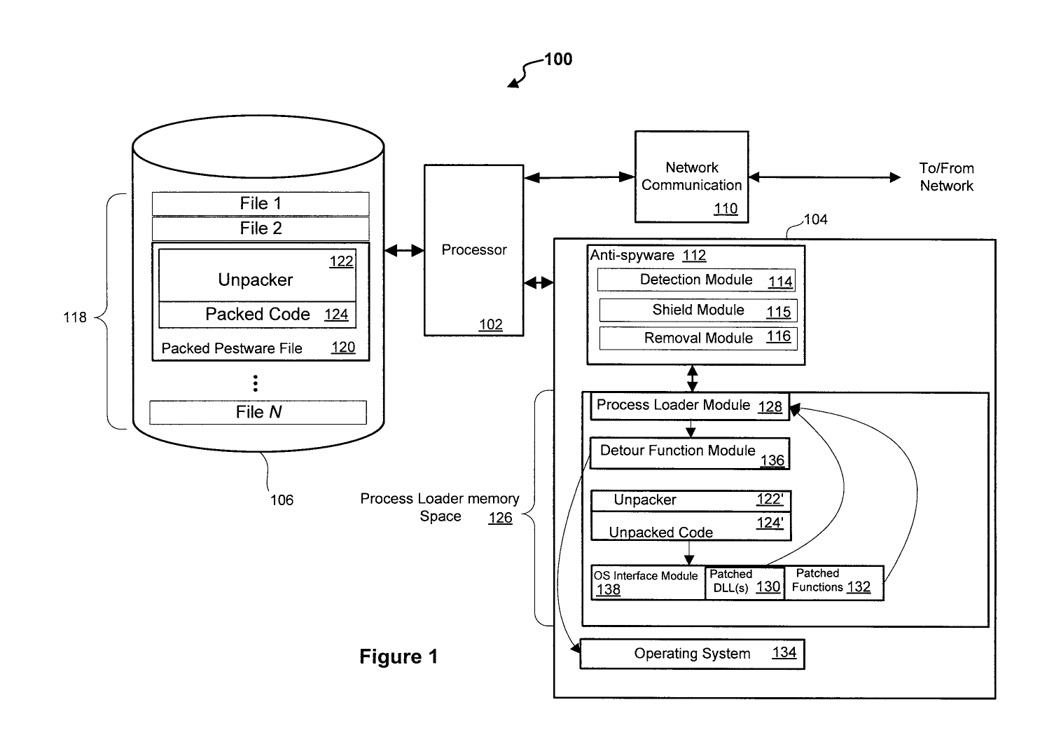

Referring now to the drawings, where like or similar elements are designated with identical reference numerals throughout the several views, and referring in particular to FIG. 1, it illustrates a block diagram 100 of a protected computer/system in accordance with one implementation of the present invention. The term “protected computer” is used herein to refer to any type of computer system, including personal computers, handheld computers, servers, firewalls, etc. This implementation includes a processor 102 coupled to memory 104 (e.g., random access memory (RAM)), a file storage device 106, and network communication 110.

As shown, the storage device 106 provides storage for a collection of N files 118 including a packed pestware file 120 that includes an unpacker portion 122 and a packed code portion 124. The storage device 106 is described herein in several implementations as hard disk drive for convenience, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be realized by multiple (e.g., distributed) storage devices.

As shown, an anti-spyware application 112 includes a detection module 114, a shield module 15 and a removal module 116, which are implemented in software and are executed from the memory 104 by the processor 102. In addition, a process-loader memory space 126 is shown that includes a process loader module 128 in communication with a detour function 136, an unpacker 122′ corresponding to the unpacker portion 122 and unpacked code 124′ corresponding to the packed code 124. Also depicted in the process-loader memory space is an operating system interface 138, which includes patched dynamic link libraries (DLLS) 130 and patched functions 132 that are in communication with the unpacked code 124′. In addition, the process loader module 128 is shown in communication with an operating system 134 via the detour function 136.

The anti-spyware application 112 and process loader module 128 can be configured to operate on personal computers (e.g., handheld, notebook or desktop), servers, firewalls or any device capable of processing instructions embodied in executable code. Moreover, one of ordinary skill in the art will recognize that alternative embodiments, which implement one or more components (e.g., the anti-spyware 112) in hardware, are well within the scope of the present invention. It should be recognized that the arrangement of the anti-spyware application 112 and the loader module 128 is logical and not meant to be an actual hardware diagram. Thus, the components can be combined or further separated in an actual implementation. Moreover, the construction of each individual component in light of the teaching herein is well-known to those of skill in the art.

In accordance with several embodiments of the present invention, the detection module 114 is configured to scan code (e.g., unpacked code) that is loaded by the loader module 128 to determine whether the code is potentially pestware code. In general, once the loader 128 has loaded code (e.g., executable code) the detection module 114 may utilize one or more techniques to determine whether the loaded code is pestware-related. As an example, selected portions of the code may be scanned at one or more offsets from a reference point in the code to determine whether the code is pestware-related. application Ser. No. 11/105,978, filed Apr. 14, 2005 entitled System and Method for Scanning Obfuscated Files for Pestware, which is incorporated herein by reference, includes additional information relative to offset scanning techniques.

The loader module 128 in this embodiment is configured to load and enable at least a portion of the code in selected ones of the N files 118 to be executed while preventing the executed code from carrying out undesirable activity on the computer 100. Beneficially, the loader module 128 enables files to be loaded, executed (e.g., at least in part), analyzed, and removed from memory in substantially less time than would be required if the operating system 134 of the computer were used to load and execute the same files. This time savings is due, at least in part, to one or more steps typically initiated by the operating system 134 that the loader module 128 avoids. For example, the operating system 134 may create a new virtual address space each time a file is loaded and perform one or more security checks. And when terminating code, the operating system 134 may have to remove memory mappings, collect and free resources as well as carry out other cleanup operations.

Although the time associated with the steps that the loader module 128 avoids may not be noticeable when just a few files are loaded, when thousands of files are serially loaded and terminated, the loader module 128 may save several minutes relative to using the operating system 134 to load files. Notably, operation of the loader module 128 is described herein with reference to embodiments where the loader 128 is loading packed code (e.g., the packed pestware file 120), but the loader module 128 in several embodiments is generally capable of loading many types of files including executable files (e.g., files organized in the Portable Executable (PE) format) and non-executable files.

Although the loader module 128 avoids one or more time consuming steps when loading and/or terminating a process, the loader module 128 may also carry out many of the same functions that are ordinarily carried out by the operating system 134. In connection with loading and executing files, for example, the loader module 128 in many variations is configured to access headers of a file and map the file from the storage device 106 to memory 104 as well as determine which DLLs the file wants to access.

In addition, in many embodiments the loader module 128 also fills an import address table of each loaded process. For example, the loader module 128 may access DLLs (e.g., kernel32), retrieve information about where functions are implemented, and then place the addresses of the functions into the appropriate fields in the import address table of the loaded code. In many variations, however, the loader module 128 places addresses of functions, which are internal to the loader module 128, within the import address table of the loaded process so that when a loaded process attempts to access a function, it is routed to code associated with the loader module 128 (e.g., the loader module 128 itself or other code associated with the anti-spyware application 112) instead of the operating system 134.

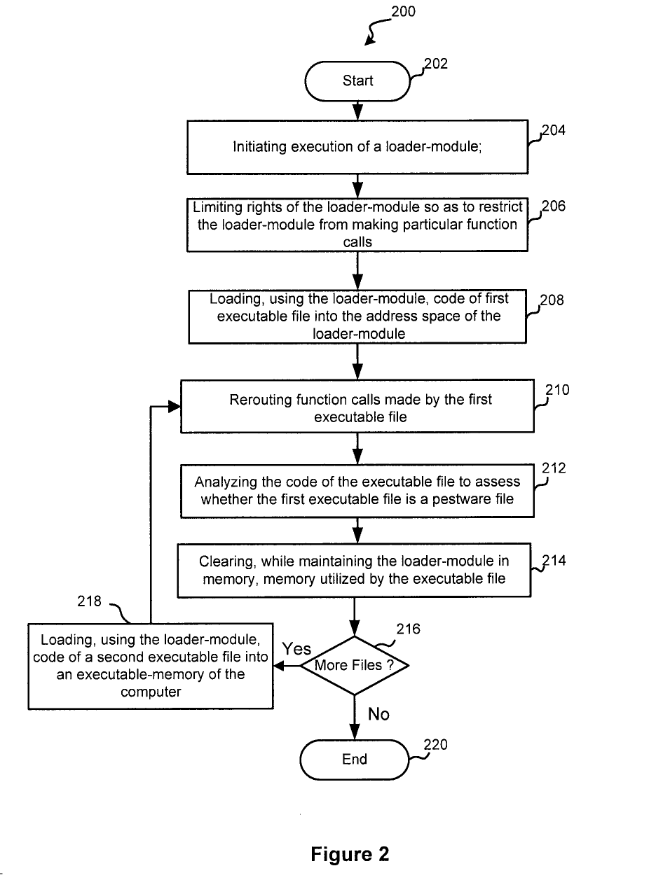

As discussed further herein with reference to FIG. 2, when the loader module 128 is loaded, in many embodiments it is restricted in terms of the activities it may perform. For example, the anti-spyware application 112 may limit the activities (e.g., function calls) of the loader module 128 by passing activity-limiting security tokens to the operating system 134 in connection with a CreateProcess call that is made to launch the loader module 128. In this way, the operating system 134 limits rights of the loader module 128, and hence, helps to prevent processes (e.g., potential pestware processes) that are loaded and executed by the loader module 128 from causing damage to the computer 100. As an example, the loader module 128 may be allowed to read files, but not allowed to write to files, create other processes or access the network communication module 110.

As discussed above, the loader module 128 may place addresses pointing back to the loader module 128 within an import address table of each of the loaded processes. But loaded processes may also attempt to dynamically obtain access to functions by retrieving information from DLLs (e.g., kernel32) to determine whether a function is exported by the DLLs. As a consequence, as additional security, in addition to patching the import address table of each loaded process, in some variations code associated with the operating system 134 is altered (e.g., by the loader module 128) so that particular functions provided by the operating system 134 are rendered inaccessible.

As depicted in FIG. 1, for example, the loader module 128 enumerates DLLs that have been loaded by the operating system 134 for the loader module 128 and patches an export address table of at least a portion of the enumerated DLLs to create the patched DLLs 130. In the exemplary embodiment depicted in FIG. 1, the DLLs are patched so that the export address tables in the patched DLLs 130 point back to the loader module 128 instead of the functions ordinarily provided by operating system 134. In a WINDOWS-based operating system for example, the loader module 128 may create the patched DLLs 130 depicted in FIG. 1 by patching the Kernel32 DLL and NTDLL.

In addition, the loader module 128 in the exemplary embodiment also patches at least a portion of the actual functions (e.g., potentially dangerous functions such as CreateProcess and OpenRegistry) that the export address table(s) point to so that if a pestware process attempts to access a function directly (e.g., without referring to an export address table), the first few instructions of the function point the pestware process back to the loader module 128.

As a consequence, whether a pestware process loaded by the loader module 128 attempts to look up a location of a function, or directly jumps to a known location of a function, in many instances the pestware process will be routed back to the loader module 128 and a determination may be made (e.g., by the loader module 128 and/or the anti-spyware application 112) whether to stop the pestware process, unload it or refer the pestware process on to the actual function depending upon the type of call the pestware process was attempting to make. Thus, the loader module 128 in this embodiment both increases security (e.g., by limiting access to potentially dangerous functions) and retains a tight management over loaded processes by watching and controlling the activities of the loaded processes.

Also depicted in memory 104 is a detour function 136 that resides at a location in memory that is intended to be unknown to any processes that are loaded by the loader module 128. In general, the detour function 136 in this embodiment enables the loader module 128 to make one or more function calls to carry out its function of loading and executing files. For example, the detour function 136 may include function code associated with a CreateFile so that when the loader module 128 loads a file, the loader module 128 calls the detour function 136 to be routed to the CreateFile functionality.

Although certainly not required, the loader module 128 may be configured to directly access (e.g., without using calls to the operating system 122) the storage device 106 to retrieve information from the N files 118. In addition to substantially increasing the rate at which information is retrieved from the storage device 106, directly accessing the storage device 106 also circumvents particular varieties of pestware (e.g., rootkits), which are known to patch, hook, or replace system calls with versions that hide information about the pestware. Additional information about directly accessing (e.g., without using OS API calls) a storage device and removing locked files is found in U.S. application Ser. No. 11/145,593, Attorney Docket No. WEBR-009/00US, entitled “System and Method for Neutralizing Locked Pestware Files,” which is incorporated herein by reference in its entirety.

In the exemplary embodiment depicted in FIG. 1, the packed pestware file 120 includes an unpacker portion 122, which when executed, unpacks the packed code 124 so that it may be analyzed by the detection module 114. Although many files are packed merely for purposes of reducing file size and perhaps load times, it has been found that some generators of pestware pack pestware code to render pestware-identification techniques ineffective. Consequently, typical scanning techniques are unable to determine that the packed pestware file 120 is a pestware file.

The packed pestware file 120 may be a pestware file that is obfuscated (e.g., intentionally disguised or hidden) by encryption, packing algorithms (e.g., UPX, Aspack, FSG, PECompact), as well as a file obfuscated by compression techniques; weak encryption (e.g. carrying out XOR operations on the file); proprietary encryption/compression, which may utilize variations of known packing routines; file repackaging, which involves the file re-encrypting/compressing itself after being run (e.g., after the file is run, the file grabs data from the machine or internet then repackages itself and writes its new copy to disk); and separating the file into parts such that the file, in the form of multiple segments, is not executable, but once packaged together becomes an executable file.

While referring to FIG. 1, simultaneous reference will be made to FIG. 2, which is a flowchart 200 depicting a method in accordance with one embodiment. Although reference is made to the embodiment depicted in FIG. 1, it should be recognized that he method depicted in FIG. 2 may be adapted to other embodiments. As shown, execution of the loader module 128 is initiated (Blocks 202, 204), and in many embodiments rights of the loader module 128 are limited so as to restrict the loader module 128 from making particular calls to the operating system (Block 206). As described above, the operating system 134 may be used to limit rights of the loader module 128 when it is initiated.

As shown, once the loader module 128 is initiated, it loads at least a portion of a first file into memory of the computer (e.g., the process-loader memory space 126)(Block 208). In many embodiments, the loader module 128 is prompted by the anti-spyware application 112 to load the first file as part of a scan of the N files 118 stored on the storage device 106. As depicted in FIG. 1, the loader module 128 loads the first file in the process loader memory space 126 that is set up and controlled by the loader module 128.

Once loaded, if the first file is an executable file, the loader module 128 allows code of the first file to execute as a process in the process loader memory 126, but potentially dangerous function calls made by the executing code are rerouted to prevent the code from carrying out potentially dangerous operations (e.g., creating another process or attempting to access the network communication module 110)(Block 210). As discussed, the loader module 128 in many embodiments fills an import address table of each loaded process to route at least some system calls back to the loader module 128.

In addition, as depicted in FIG. 1, if the loaded process accesses the patched DLLs 130, the process may be referred back to the process loader module 128 instead of the intended function. Moreover, if the loaded process attempts to directly access an intended function (e.g., CreateFile) the patched function 132 refers the process back to the loader module 128. It should be recognized that the addresses that the loader module 128 fills into the import address tables, the DLLs 130 and the functions 132 may point to a location outside of the loader module 128 that is within the loader module's 128 address space 126.

As shown in FIG. 2, while code of the first file is loaded in memory, the code is analyzed to assess whether the first file is a potential pestware file (Block 212). In many embodiments, the detection module 114 analyzes the code using one or more pestware detection techniques. For example, the detection module 114 may access a portion of the code (e.g., the first 512 Bytes) and compare a representation of the code (e.g., a message digest or cyclic redundancy check) with pestware definitions or, as discussed above, analyze portions of the code at one or more offsets from a reference point within the code for indicia of pestware.

As shown in FIG. 2, after the loaded process is analyzed, the memory utilized by the loaded process is cleared while maintaining the loader module 128 in memory (Block 212), and if there are more files to analyze (Block 216), then other files are loaded by the loader module 128 (Block 218) and the steps described with reference to Blocks 208 through 214 are repeated for each loaded file until there are no more files to analyze (Blocks 216, 220).

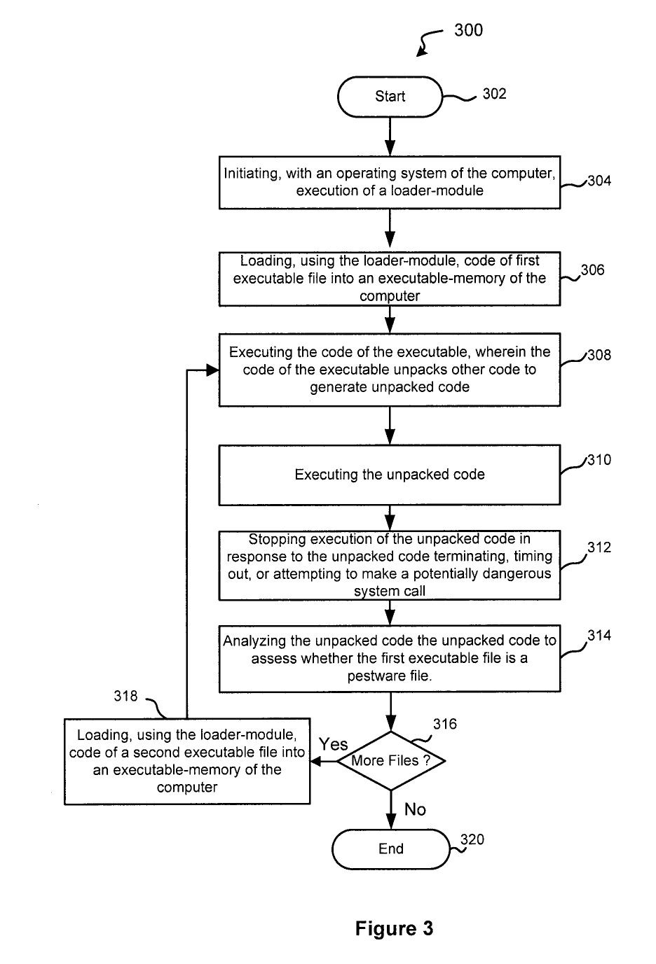

Referring next to FIG. 3, shown is a flowchart 300 depicting another method in accordance with another embodiment. As shown, in this embodiment a loader module (e.g., the loader module 128) is initially executed using an operating system (e.g., the operating system 134)(Blocks 302, 304). The loader module then loads code of an executable file (e.g., the unpacker 122) into memory of the computer and the code unpacks other code (e.g., the packed code 124) to generate unpacked code (e.g., the unpacked code 124′)(Blocks 306, 308).

As depicted in FIG. 3, although not required, in some variations the unpacked code is then allowed to execute (e.g., within the loader memory space 126) until a predetermined event occurs such as the unpacked code attempting to make a potentially dangerous system call, the unpacked code timing out or the unpacked code terminating (Blocks 310, 312). Referring to FIG. 1 as an example, if the unpacked code 124′ attempts to locate a function using the patched DLLs 130 or attempts to directly access one of the patched functions 132, the unpacked code 124′ is referred back to process loader module 128 (or another function related to the anti-spyware application 112) and depending upon the type of call made, the process loader module 128 either terminates execution of the unpacked code 124′, or after a determination is made that the call is likely safe, forwards the call (e.g., via the detour function 136) to the operating system function.

Some types of calls that may prompt the process loader 128 to stop execution of the unpacker 122′ and unpacked code 124′ are calls to access a registry of the computer, calls to open up network communications and calls to create a new process. A call that the process loader 128 may allow to occur (e.g., by forwarding the call to the operating system 134) is a memory allocation request. If the memory allocation request is for an excessive amount of memory (e.g., a gigabyte), however, the process loader 128 may stop execution of the loaded executable file.

As shown in FIG. 3, the unpacked code 124′ is analyzed to assess whether the unpacked code 124′ is pestware (Block 314). In some embodiments, the unpacked code is not executed at all and the un-executed unpacked code is analyzed (e.g., by the detection module 114). In other embodiments, however, the unpacked code is analyzed after execution of the unpacked code 124′ is terminated. Thus, the loader module 128 in many variations uses the unpacker (e.g., unpacker 122) that accompanies packed code (the packed code 124) to unpack the packed code so that the packed code may be analyzed. As a consequence, the loader module 128 in these variations effectively operates as a universal unpacker that unpacks virtually any type of packed code without having to determine the packing technique used to pack the code and without having to be updated with code to address new packing techniques.

As shown in FIG. 3, if there are more files to analyze (Block 316), then other files are loaded by the loader module 128 (Block 318) and the steps described with reference to Blocks 308 through 314 are repeated for each loaded file until there are no more files to analyze (Blocks 316, 320).

In conclusion, the present invention provides, among other things, a system and method for analyzing packed files. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

In conclusion, the present invention provides, among other things, a system and method for loading and analyzing files for indicia of pestware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for analyzing executable files on a computer comprising:
initiating, with an operating system of the computer, execution of a loader-process;
limiting rights of the loader-process so as to restrict the loader-process from particular calls to the operating system;
loading, using the loader-process, code of a first executable file into an address space of the loader-process;
analyzing the code of the first executable file to assess whether the first executable file is a pestware file;
clearing, while maintaining the loader-process in memory, memory utilized by the first executable file;
loading, using the loader process, code of a second executable file into an executable-memory of the computer; and
analyzing the code of the second executable file to assess whether the second executable file is a pestware file.

2. The method of claim 1, including:
enumerating dynamic link libraries (DLLS) that have been loaded by the operating system for the loader-process; and
altering an export address table of at least one of the dynamic link libraries (DLLS) so that the export address table no longer points to a system function.

3. The method of claim 2, wherein the altering includes altering the export address table so the export address table points to code that stops execution of the first executable file.

4. The method of claim 1, including
altering selected functions so the first executable file is unable to access code of the selected functions.

5. The method of claim 4, wherein the functions are selected from the group consisting of CreateFile, CreateProcess and OpenRegistry.

6. The method of claim 4, wherein the altering includes placing a jump instruction in the functions that points to code of the loader-process so as to prevent the second executable file from accessing the functions.

7. The method of claim 1, including
implementing a detour function that enables the loader-process to make an API call to load the first executable file.

8. The method of claim 1, wherein the analyzing includes analyzing portions of the code at offsets from a reference point.

9. The method of claim 1, wherein loading code of the second executable file includes:
loading an unpacker designed to unpack packed code; and
unpacking the packed code with the unpacker so as to generate unpacked code, the code of the second executable file including the unpacked code.

10. The method of claim 1 including:
generating a detour function, the detour function pointing to an API call of the operating system;
wherein loading includes utilizing the detour function to load the first and second executable files.

11. A system for analyzing executable files on a computer comprising:
a loader module configured to sequentially receive code from a plurality of files stored on a computer-readable medium and initiate execution of the code in a process space of the loader module, and wherein the loader module is configured to stop execution of the code in response to the code attempting to carry out particular instructions while executing; and
a detection module configured to analyze the code from each of the plurality of files after the code is loaded by the loader module.

12. The system of claim 11, wherein the loader module is configured initiate the execution of code by loading an unpacker, wherein the unpacker is configured to unpack packed code to generate executable code.

13. The system of claim 1, wherein the loader module is configured to analyze a header of each of the plurality of files so as to map the code from the plurality of files into a memory.

14. The system of claim 11, wherein the loader module is configured to fill in an import address table of each of the plurality of files.

15. The system of claim 11, wherein at least one of an export address table of a dynamic link library (DLL) associated with the loader module and an exported function associated with the DLL are patched so as to direct any calls from the code back to the loader module.

16. The system of claim 15, wherein the loader module is configured to assess a memory allocation call from the code, and if the call is safe, direct the call to the operating system.

17. A processor-readable medium including instructions for analyzing executable files on a computer, the instructions including instructions for:
initiating, with an operating system of the computer, execution of a loader-process;
loading, using the loader-process, code of first executable file into an address space of the loader-process;
analyzing the code of the first executable file to assess whether the first executable file is a pestware file;
clearing, while maintaining the loader-process in memory, memory utilized by the first executable file;
loading, using the loader process, code of a second executable file into an executable-memory of the computer; and
analyzing the code of the second executable file to assess whether the second executable file is a pestware file.

18. The processor-readable medium of claim 17, including instructions for:
enumerating dynamic link libraries (DLLS) that have been loaded by the operating system for the loader-process; and
altering an export address table of at least one of the dynamic link libraries (DLLS) so that the export address table no longer points to a system function.

19. The processor-readable medium of claim 18, wherein the instructions for altering include instructions for altering the export address table so the export address table points to code that stops execution of the first executable file.

20. The processor-readable medium claim 17 including instructions for altering selected functions so the first executable file is unable to access code of the selected functions.
